(19) United States
(12) Patent Application Publication
(10) Pub. No.: US 2025/0135607 A1
(43) Pub. Date: May 1, 2025

(54) WIRE SUPPORTING CLAMPS

(71) Applicant: Affordable Wire Management, LLC, Bedminster, NJ (US)

(72) Inventors: Scott Robert Rand, Bedminster, NJ (US); Daniel Robert Smith, Bedminster, NJ (US); Peter Mark Hruby, Bedminster, NJ (US)

(21) Appl. No.: 18/837,802

(22) PCT Filed: Feb. 14, 2023
(86) PCT No.: PCT/US23/62543

§ 371 Date: Aug. 12, 2024

Related U.S. Application Data
(60) Provisional application No. 63/267,980, filed on Feb. 14, 2022.

(51) Int. Cl. B25B 5/10; B25B 5/14; H02G 1/06

(52) U.S. Cl. CPC B25B 5/104; B25B 5/147; H02G 1/06

(57) ABSTRACT

A wire supporting clamp is provided and includes a base member, a support spine, a first cable saddle, and a first compression leg. The base member has a proximal end and a distal end. The support spine is arranged on the proximal end of the base member and extends from the base member. The first cable saddle is positioned on the base member. The first compression leg is deformably connected to the support spine and spaced apart from the first cable saddle. The base member includes a first aperture arranged therein, and the first compression leg includes a second aperture arranged therein. The first and second aperture are aligned such that the first and second aperture are configured to have a securing member pass therethrough, where the securing member is configured to apply pressure to the first compression leg to deform the first compression leg into a compressed position.

### CROSS-REFERENCE TO RELATED APPLICATIONS

The present application claims priority under 35 U.S.C. § 119 (e) to U.S. Provisional Patent Application No. 63/267,980 titled “COMBINATION CLAMP”, filed on Feb. 14, 2022, the entire contents of which is hereby expressly incorporated by reference herein.

### FIELD

The present application generally relates to wire supporting clamps for cables, and more specifically, to wire supporting clamps for messenger cables and equipment ground conductors found on utility-scale solar generation plant.

### BACKGROUND

Energy production and transmission infrastructures, such as Photovoltaic (PV) Solar energy production, utilize a number of cable types to convey electrical current, and/or signal data from source facilities to consumer locations. In large-scale solar power plants, cables can convey electrical current and signal data from solar panels to other production and/or transmission equipment within the plant.

Energy production and transmission infrastructures utilize a number of cable types to convey electrical current, and/or signal data from source facilities to consumer locations. In large-scale solar power plants, cables can convey electrical current and signal data from solar panels to other production and/or transmission equipment within the plant. The cables can be arranged in underground or above-ground configurations. Above-ground cable configurations can require cables to be supported in the air in a secure and safe manner, which is capable of withstanding harsh environmental conditions.

### SUMMARY

Wire supporting clamp for cables are provided.

In an embodiment, a wire supporting clamp is provided including a base member, a support spine, a first cable saddle, a first compression leg, a second cable saddle, and a second compression leg. The support spine extends from the base member. The first cable saddle is positioned on the base member. The first compression leg is positioned on the support spine and spaced apart from the first cable saddle. The second cable saddle is positioned on the base member. The second compression leg is positioned on the support spine and spaced apart from the second cable saddle.

The first and second compression legs can have a variety of configurations. For example, in some embodiments, the first compression leg can be deformably connected to the support spine. In other embodiments, the first compression leg can be positioned on a first side of the support spine. In certain embodiments, the second compression leg can be positioned on a second side of the support spine, where the first side is opposite the second side. In some embodiments, the second compression leg can be deformably connected to the support spine.

The base member can have a variety of configurations. For example, in some embodiments, the base member can include a first aperture arranged therein, and the first compression leg can include a second aperture arranged therein, where the first aperture and the second aperture are aligned with each other. In other embodiments, the first aperture and the second aperture can be configured to have a securing member pass therethrough, where the securing member can be configured to apply pressure to the first compression leg to deform the first compression leg into a compressed position. In certain embodiments, the securing member can be configured to connect the wire supporting clamp to a support structure while also deforming the first compression leg.

The first and second cable saddles can have a variety of configurations. In some embodiments, the first cable saddle and the second cable saddle are electrically coupled together through the wire supporting clamp to allow current to flow from the first cable saddle to the second cable saddle. In other embodiments, the first cable saddle can be configured to connect a first cable to the wire supporting clamp, and the second cable saddle can be configured to connect a second cable to the wire supporting clamp. In certain embodiments, the first cable and the second cable can be spaced apart from each other to avoid physical contact while engaged with the first cable saddle and second cable saddle, respectively.

In some embodiments, the wire supporting clamp can include a retention tab positioned on a distal end of the base member, distal to the first cable saddle.

In some embodiments, the wire supporting clamp can be symmetrical along the support spine.

In an embodiment, a wire supporting clamp is provided that includes a base member, a support spine, a first compression leg, and a second compression leg. The base member has a proximal end and a distal end. The support spine extends from the base member. The first compression leg is positioned on the proximal end of the base member and configured to form a first cable saddle when the first compression leg is in a compressed position. The second compression leg is positioned on the distal end of the base member and configured to form a second cable saddle when the second compression leg is in a compressed position.

In some embodiments, the support spine can at least partially form a portion of the first cable saddle and a portion of the second cable saddle. In other embodiments, the wire supporting clamp can be symmetrical along the support spine

In some embodiments, the first compression leg can be deformably connected to the proximal end of the base member, and the second compression leg can be deformably connected to the distal end of the base member.

The first and second cable saddles can have a variety of configurations. For example, in some embodiments, the first cable saddle can be configured to connect a first cable to the wire supporting clamp, and the second cable saddle can be configured to connect a second cable to the wire supporting clamp. In other embodiments, the first cable and the second cable can be spaced apart from each other to avoid physical contact while engaged with the first cable saddle and second cable saddle, respectively. In certain embodiments, the first cable saddle and the second cable saddle can be electrically coupled together through the wire supporting clamp to allow current to flow from the first cable saddle to the second cable saddle.

In an embodiment, a wire supporting clamp is provided including a base member, a support spine, a first cable saddle, and a first compression leg. The base member has a proximal end and a distal end. The support spine is arranged on the proximal end of the base member and extends from the base member. The first cable saddle is positioned on the base member. The first compression leg is deformably connected to the support spine and spaced apart from the first cable saddle.

In some embodiments, the wire supporting clamp further includes a retention tab positioned on the distal end of the base member, distal to the first cable saddle.

The base member can have a variety of configurations. For example, in some embodiments, the base member can include a first aperture arranged therein, and the first compression leg can include a second aperture arranged therein, where the first aperture and the second aperture are aligned with each other. In other embodiments, the first aperture and the second aperture can be configured to have a securing member pass therethrough, where the securing member can be configured to apply pressure to the first compression leg to deform the first compression leg into a compressed position. In certain embodiments, the securing member can be configured to connect the wire supporting clamp to a support structure while also deforming the first compression leg.

In another embodiment, the first compression leg can include a curved surface corresponding to and aligned with the first cable saddle. In other embodiments, the curved surface and the first cable saddle can secure the wire supporting clamp to a wire arranged between the curved surface and the first cable saddle when the first compression leg can be in a compressed position.

### BRIEF DESCRIPTION OF THE DRAWINGS

These and other features will be more readily understood from the following detailed description taken in conjunction with the accompanying drawings, in which:

FIG. 1 is a perspective view of an embodiment of a wire supporting clamp;

FIG. 2 is a side view of the wire supporting clamp of FIG. 1;

FIG. 3 is a top view of the wire supporting clamp of FIG. 1;

FIG. 4 is a perspective view of the wire supporting clamp of FIG. 1 positioned on an embodiment of a post bracket;

FIG. 5 is a perspective view of the wire supporting clamp of FIG. 1 positioned on an embodiment of a post bracket;

FIG. 6 is a perspective view of the wire supporting clamp and post bracket of FIG. 5 in a compressed position;

FIG. 7 is a side perspective view of the wire supporting clamp and post bracket of FIG. 6;

FIG. 8 is a perspective view of an embodiment of a wire supporting clamp;

FIG. 9A is a side view of the wire supporting clamp of FIG. 8;

FIG. 9B is a side view of the wire supporting clamp of FIG. 8 in a compressed position;

FIG. 9C is a perspective view of the wire supporting clamp of FIG. 8 in a compressed position;

FIG. 10 is a perspective view of an embodiment of a wire supporting clamp;

FIG. 11 is a side view of the wire supporting clamp of FIG. 10;

FIG. 12 is a top view of the wire supporting clamp of FIG. 10;

FIG. 13 is a perspective view of the wire supporting clamp of FIG. 10 positioned on an embodiment of a post bracket;

FIG. 14 is a perspective view of an embodiment of a wire supporting clamp;

FIG. 15 is a side view of the wire supporting clamp of FIG. 1 in an uncompressed position;

FIG. 16 is a side view of the wire supporting clamp of FIG. 1 in a compressed position;

FIG. 17 is a perspective view of the wire supporting clamp of FIG. 14 positioned on an embodiment of a post bracket;

FIG. 18 is a side perspective view of the wire supporting clamp and post bracket of FIG. 17;

FIG. 19 is a perspective view of the wire supporting clamp of FIG. 14 positioned on an embodiment of a post bracket; and

FIG. 20 is a perspective view of the wire supporting clamp of FIG. 14 positioned on an embodiment of a post bracket.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Energy production and transmission infrastructures utilizes a number of cable types to convey electrical current, signal data, and grounding paths from source facilities to consumer locations. In large-scale solar power plants, cables can convey electrical current, signal data, and ground paths from solar panels to other production and/or transmission equipment within the plant. The cables can occasionally fail creating an electrical short which can lead to electrical safety hazards and loss of energy production. In order to prevent such a short, a current-carrying conductor is specifically installed to carry this electrical short current, and is typically referred to as a Ground Wire, or Ground Cable or Ground Conductor, or Equipment Grounding Conductor (“EGC”). The cables can be arranged in underground or aboveground configurations. The aboveground cable configurations, such as those used in utility-scale solar power generation and transmission systems, can be deployed and managed using a messenger cable and a cable hanger system. The cable hanger can support the cables, such as power cables, in an organized and serviceable manner. A cable hanger can couple to support structures, such as a messenger cable, which is typically a stranded wire rope that is used to mechanically support the cable hangers and cables. The messenger cable can be routed between posts, columns, or other vertically oriented components located throughout an electrically connected grid to convey the cables from one location to another. In addition to the power cables, the EGC may be a separate cable and routed alongside the power cables to ensure that the electrically connected grid is free from electrical hazards and the conductive components are safe-to-touch.

The EGC may run in parallel next to the messenger cable as a ground cable, where typically the EGC is coupled to the same posts, columns, or other vertically orientated components that the messenger cable attaches to. This ensures that the posts are electrically bonded to one another, and that the posts are at equal electrical potential. This reduces the risk of electrical shock hazards on site. Due to local and national standards and regulations, the EGC must be coupled to the posts using a device that is listed and certified to the UL Safety Standard, UL467. When the EGC is supported aboveground, the EGC material can be either Copper, Aluminum, or Copper-Clad Aluminum, per the National Electric Code (NEC) and when the EGC is buried underground, the EGC material must be Copper, per the NEC. Typically, an electrically connected grid, such as a solar power plant, will have both aboveground and belowground EGC's. Typically, the messenger cable and ground cable are coupled to the posts, columns, or other vertically oriented components with separate devices, typically a clamp-style device. Some implementations of the current subject matter can facilitate the use of a messenger cable clamp and an EGC clamp in a single part.

The messenger cable and ground cable, such as those used in utility scale solar power generation and transmission systems, can be deployed, managed, and secured using a wire supporting clamp. The messenger cable is typically used to support a cable hanger and cable system and the ground cable is typically installed adjacent to the messenger cable and used to create equal electrical potential between posts. The messenger cable is typically a Galvanized Steel Wire Rope, but other types of materials and cables can be used as the messenger cable, such as Bare Aluminum Conductor, Copper-Clad Steel Cable, or Common Utility Conductors such as ACSR, AAC, or AAAC. The ground cable is typically a bare copper cable, but other types of materials and cables can be used as the ground cable, such as Bare Aluminum Conductor, Copper-Clad Steel Cable, or Common Utility Conductors such as ACSR, AAC, or AAAC. Due to its design, a wire supporting clamp can be deployed anywhere along the messenger cable or ground cable. In other words, the messenger cable or grounding cable can be dropped-in and coupled to the wire supporting clamp at any location along its lengths. In addition, the wire supporting clamp can be made from material that will not galvanically corrode with the Galvanized Steel Wire Rope or the bare Copper Ground Cable or the Steel Posts or Steel Structures that the wire supporting clamp attaches to. Additionally, the wire supporting clamp can be made from material that will last 35 years in an outdoor and UV environment. Moreover, the wire supporting clamp can separate and eliminate any contact with the messenger cable and the EGC, eliminating any galvanic corrosion between the messenger cable and EGC, and complying with the galvanic corrosion requirements of the Solar Safety Standard, UL2703. In addition, the wire supporting clamp can reduce the amount of installation steps by combining both of the messenger cable clamp and EGC clamp functions into a single part.

Using a single device rather than two separate devices provides labor benefits during field use, for example, because installing a single device is faster than installing two separate devices. Furthermore, occasionally holes for fastening the devices to the posts need to be field drilled, so less holes are required to be drilled for the single device wire supporting clamp. In addition, a single wire supporting clamp device can be advantageous of the current method of using two separate devices due to less material use and thus a more cost-effective solution compared to two separate devices.

Wire supporting clamps can have various implementations, which are used to support and clamp down cables, such as a messenger cable and a ground cable. Implementations of the clamp disclosed herein can include a support surface, a first cable saddle on one side to fit a specific size cable, and a second cable saddle having angled ridges on the other side to fit a range of cable sizes. Each cable saddle can include fastening holes that are used to both compress the clamp down on the circular-shaped members and fasten the clamp to a post bracket. In some implementations, a wire supporting clamp can include cable saddles that vary in in size. Additionally, in some implementations, a wire supporting clamp can be symmetrical and similar in shape along a center axis, where any compression legs, base members, and cable saddles are mirrored across a centers spine support.

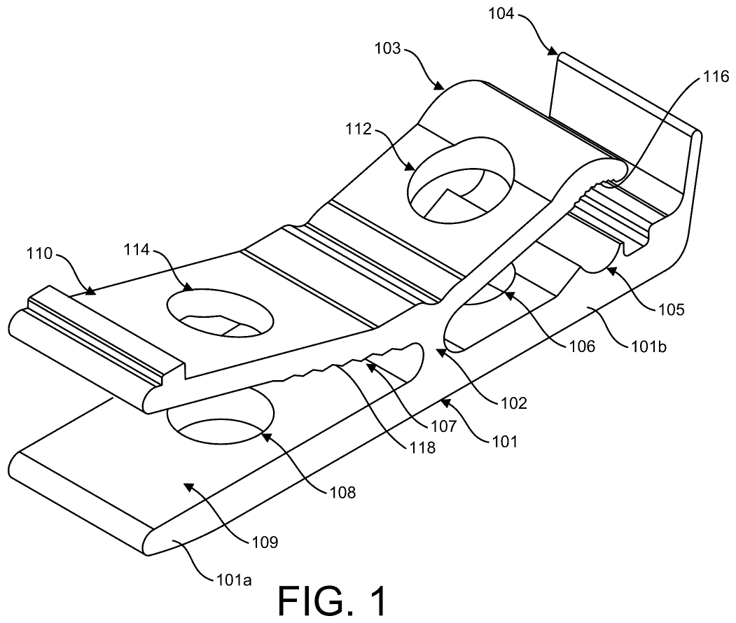

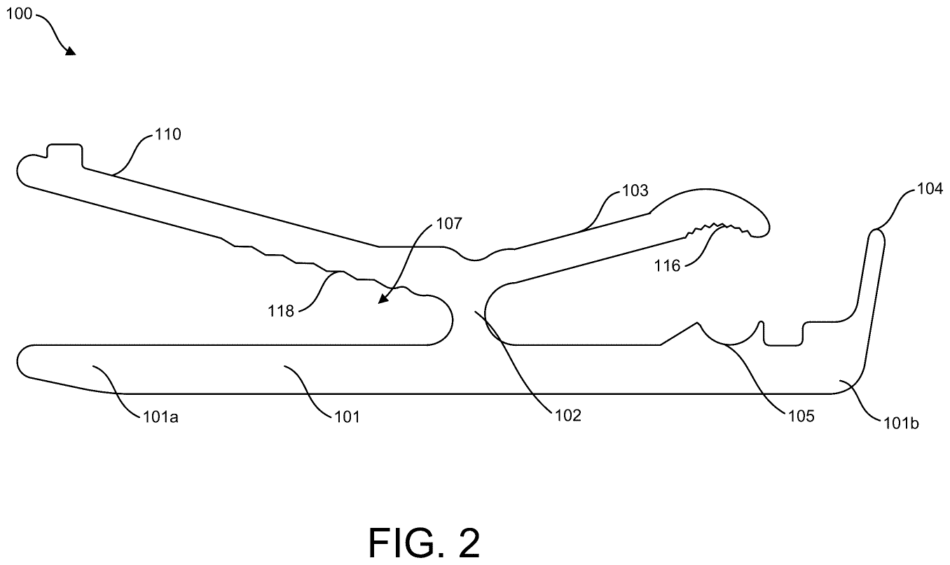

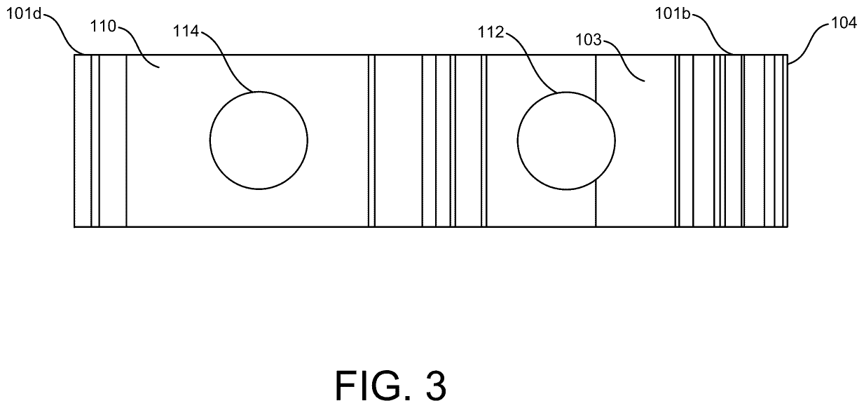

FIGS. 1-3 illustrate an exemplary implementation of a clamp 100. The clamp 100 incudes a base member 101, a support spine 102, a messenger cable saddle 105, and a cable support surface 109. The clamp 100 is configured to secure a messenger cable and ground cable running along the length of a solar array, where an above-ground wire management system is deployed. The wire supporting clamp 100 can be attached to the support structure that supports the solar panels, as described in greater detail below.

The base member 101 includes a proximal end 101a and a distal end 101b arranged opposite the proximal end 101a. Arranged between the proximal end 101a and distal end 101b is the support spine 102. Arranged adjacent the proximal end 101a is an aperture 108 that extends through the base member 101. Additionally, arranged adjacent the distal end 101b is an aperture 106 which extends through the base member 101. The apertures 106 and 108 are arranged to help secure the clamp 100 to a support surface, as will be described in greater detail below.

The support spine 102 extends upwardly from the base member 101 in a vertical direction. The support spine 102 can be integral with the base member 101, and is configured to serve as a mounting point for compression legs 103 and 110.

In an exemplary implementation, the clamp 100 can be manufactured as one single piece. The clamp 100 can be manufactured by an extrusion process and then can be cut to the desired width, or can be formed through a die casting process. In an exemplary implementation, the extruded thickness of the clamp 100 can be within a range of 0.375-1.5 inches, and preferably around 1.00 inches. The clamp 100 can be manufactured from material such as 6063-T5 Aluminum. However, various other materials can be used to form the clamp 100, and should be appreciated, such as copper, steel, zinc, bronze, aluminum, or plastics, or a combination of such materials.

The wire supporting clamp can be configured to hold larger or smaller cabling depending on the requirements of a deployed usage. For example, the messenger cable saddle and ground cable support surface may be increased or decreased in size. This is advantageous as a smaller or larger messenger cable may need to be used depending on the weight and load requirements or a smaller or larger ground cable may need to be used depending on the fault current requirements.

Also arranged on the base member 101 is a cable saddle 105. The cable saddle 105 is arranged distal to the aperture 106 and is configured to engage with a cable arranged within the cable saddle 105. The cable saddle 105 includes a curved surface which corresponds to a variety of different sized cables which can be arranged in the cable saddle 105. The cable saddle 105 can be integral with the base member 101.

Arranged distal to the cable saddle 105 and on the distal end 101b is a retention tab 104. Before the messenger cable is fully installed, field conditions, such as wind, or installers moving the messenger cable, can cause the messenger cable to move around. The retention tab 104 is designed to prevent a cable from dislodging and being removed from the clamp 100 before the compression leg 103 is placed into a compressed position such that the cable will be lodged between the cable saddle 105 and the compression leg 103. The retention tab 104 extends substantially perpendicular to the base member 101.

As soon above compression legs 103, 110 arranged on the support spine 102. The compression leg 110 along with the cable support surface 109 of the base member 101 form a cable saddle 107. Arrange on the underside of the compression leg 110 are ridges 118 which can help further secure cable arranged within the cable saddle 107. An aperture 114 is arranged within the compression leg 110 and can be vertically aligned with the aperture 108. As stated below in greater detail, the apertures 108, 114 can be used in combination with a securing member (e.g., a nut and bolt) in order to both secure the clamp 100 to a support surface, along with the deforming the compression leg 110 in the direction towards the cable support surface 109 in order to secure a cable arranged in the cable saddle 107. In addition to being deformable to secure cable within the cable saddle 107, the compression leg 110 can also be deformed in order to release a cable from the cable saddle 107. The compression leg 110 can be deformed multiple times in order to secure and release a cable with the cable saddle 107 without limiting the securing strength of the cable saddle 107.

Arranged on opposite side of the support spine 102 is the compression leg 103. Similar to the compression leg 110, the compression leg 103 includes an aperture 112 which aligns with the aperture 106 of the base member 101, which can be used to both secure the clamp 100 to a support surface and deform the compression like 103. Arranged on a distal end of the compression leg 103 is a curved surface 116. The curved surface 116 is vertically arranged over the cable saddle 105. The curved surface 116 corresponds with the curvature of the cable saddle 105 such that when the compression leg 103 is in a compressed position, a cable arranged in the cable saddle 105 will be secured to the clamp 100 by the friction between the curved surface 116 and the cable saddle 105. The curved surface 116 can also include ridges to further help secure a cable to the clamp 100. Similar to the compression leg 110, the compression leg 103 can be deformed multiple times in order to secure and release a cable with the cable saddle 105 without limiting the securing strength of the cable saddle 105.

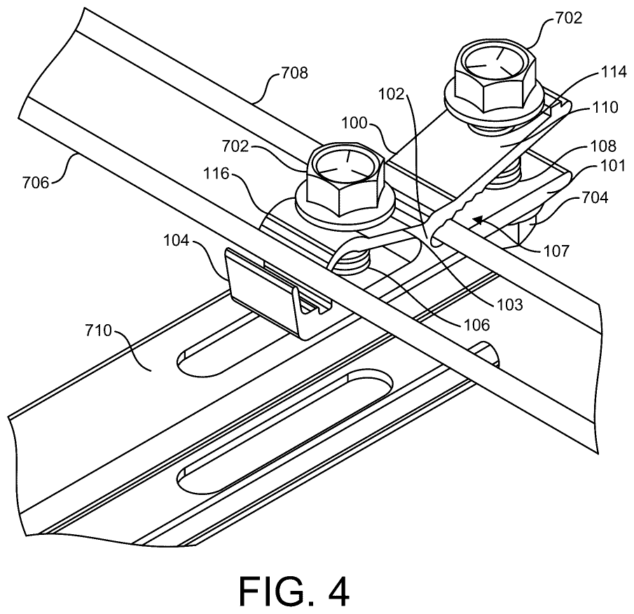

As illustrated in FIG. 4, in order to secure cables to the clamp 100, the clamp 100 is attached to the support structure by bolts 702. A bolt 702 or other fastener is inserted into the apertures 106, 112, and then inserted into the support structure. A nut 704 is used on the other side of the bolts 702 to secure the clamp 100 to the support structure. The cables 706, 708 are then placed into the cable saddles 105, 107, respectively. The bolts 703 are torqued to a specified torque value that will cause the compression legs 103, 110 to deform and compress towards the cable saddles 105, 107, causing the compression leg 103 to compress tightly around the cable 706 arranged within the cable saddle 105, and causing the compression leg 110 to compress tightly around the cable 708 arranged within the cable saddle 107. The clamping of the compression legs 103, 110 prevent the cables 706. 708 from slipping out of the clamp 100.

The curved surface 116 of the compression leg 103 can help aid in keeping the cable 706 within the cable saddle 105. Additionally, the cables 706, 708 deployed can come in a range of sizes, so the compression leg 110 is angled with respect to the cable support surface 109, such that a range of cable sizes can be installed into the clamp 100.

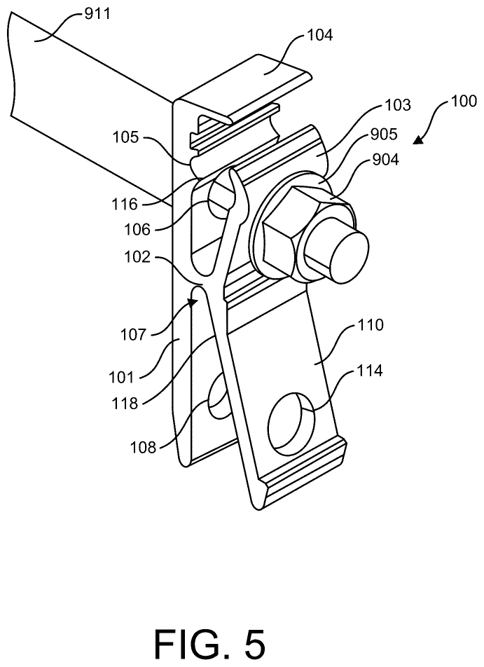

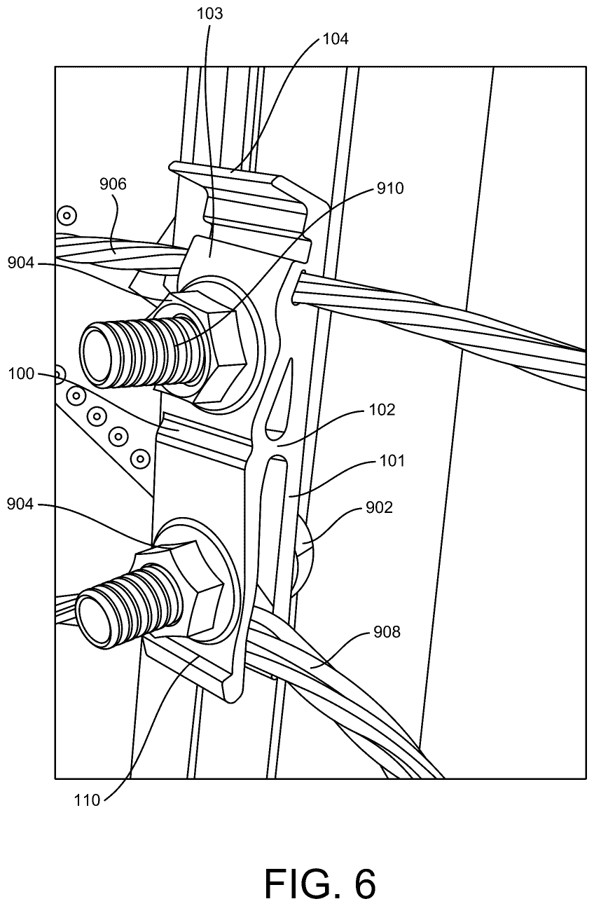

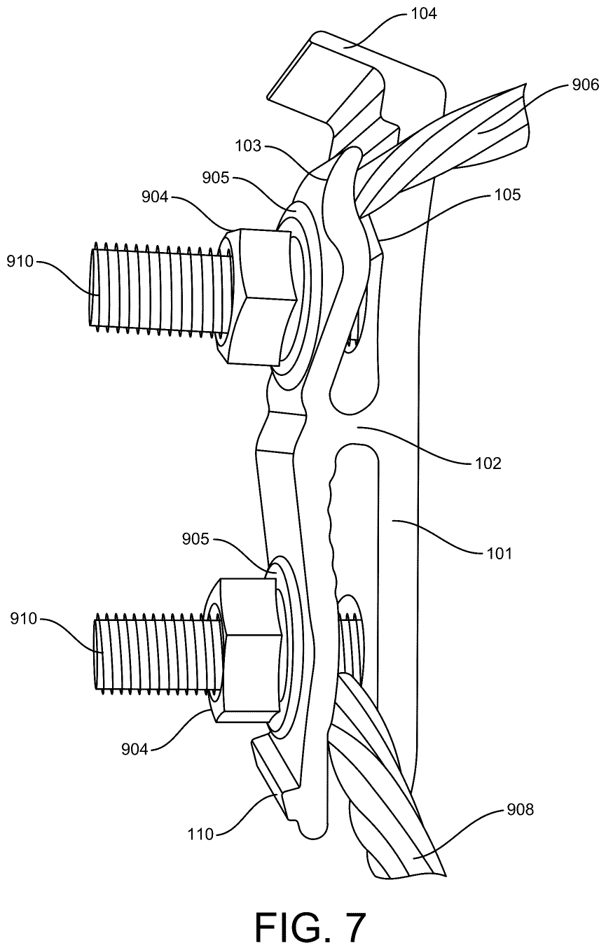

As shown in FIGS. 4-7, the wire supporting clamp can be installed in various positions and orientations, providing flexibility for the installer and the surface used to couple the wire supporting clamp on. FIG. 4 illustrates a fully installed view of the non-compressed clamp 100, bolts 702, nuts 704, a cable 706, a cable 708, and the solar panel support structure 710. FIG. 5 illustrates the non-compressed clamp 100 secured to a bolt 911 using only the apertures 106, 112. FIGS. 6-7 illustrate a fully installed compressed clamp 100, bolts 902, nuts 904, a cable 906, a cable 908, and the solar panel support structure 910. As shown in FIGS. 4-7, the wire supporting clamp 100 described herein includes features to couple both the messenger cable and ground cable to the solar panel support structures, which is advantageous to the current method of using two separate devices to couple the messenger cable and ground cables to the support structures. Additionally, as described below, only one cable saddle of the clamp 100 may be required if only a single cable is being secured.

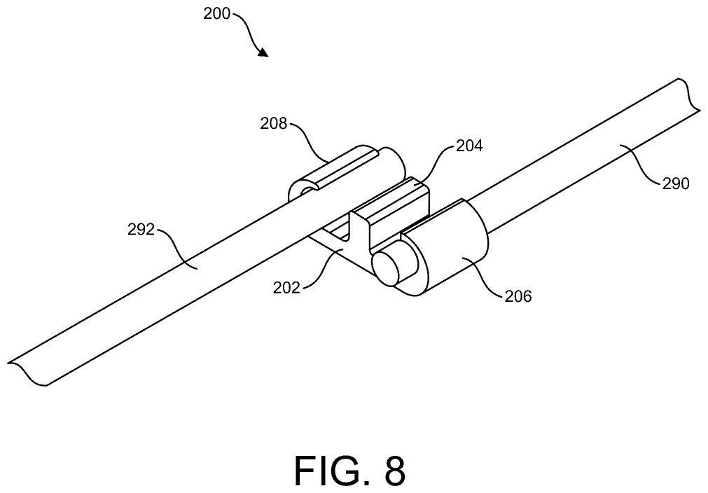

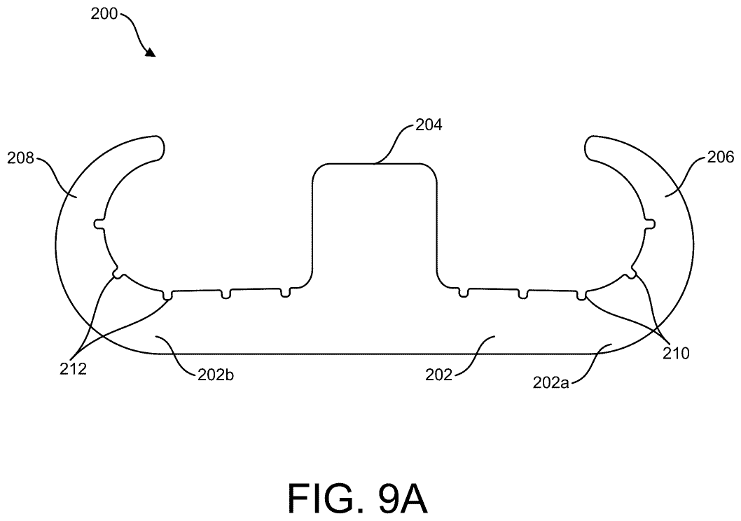

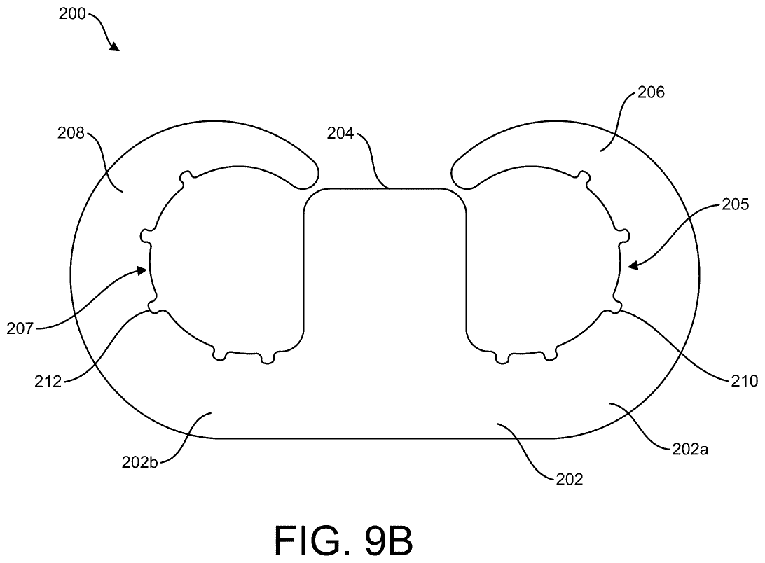

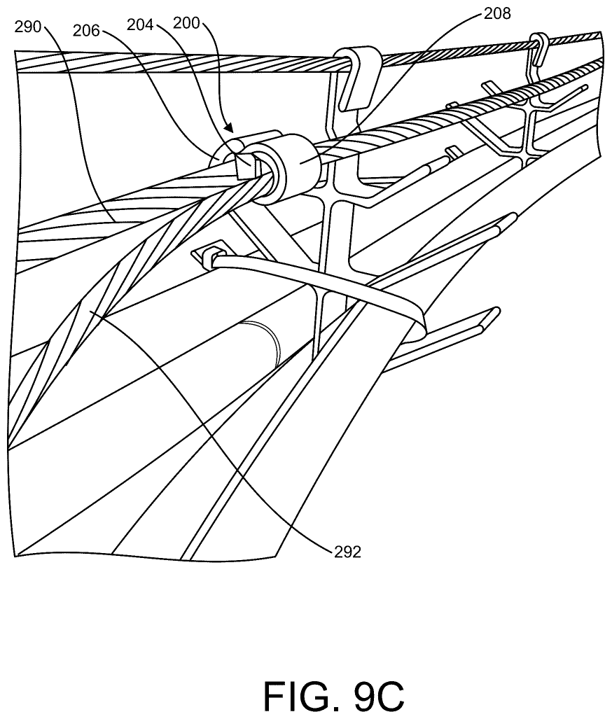

FIGS. 8-9C illustrate another embodiment of a wire supporting clamp 200 configured to couple, bond, and separate two EGCs/cables of different materials. For example, the wire supporting clamp 200 can be configured to bond and couple an aboveground aluminum EGC to a below ground copper EGC and meet all of the galvanic requirements of the UL2703 Standard. As shown in FIG. 9A, the wire supporting clamp 200 would be manufactured in an “open” position. The clamp 200 generally includes a base member 202, a support spine 204, a first compression leg 206, and a second compression leg 208. Similar to the clamp 100, the clamp 200 can be made from a material that can be deformed multiple times in order to secure and release cables arranged within the clamp 200. The support spine 204 extends upward from the base member 202. The base member 202 includes a proximal end 202a and a distal end 202b. Arranged on the proximal end 202a is a compression leg 206. The compression leg 206 curves upward from the base member 202, and forms a gap between the support spine 204 and the compression leg 206 to allow cable to be inserted. Additionally, arranged on the distal end 202b is a compression leg 208. Similar to the compression leg 206, the compression leg 208 curves upward from the base member 202 informs a gap between the support spine 204 and the compression leg 208 to allow cable be inserted.

In order to secure cables 290, 292 within the clamp 200, the compression legs 206, 208 can be deformed in order to form cable saddles 205, 207. The base member 202 and the compression legs 206, 208 can include relief cuts 210, 212, which help in the formation of the compression legs 206, 208. As shown in FIG. 9B, when the compression legs 206, 208 are in a compressed position, the support spine 204 forms a portion of the cable saddles 205, 207 along with the compression legs 206, 208.

A battery-powered crimping tool is can be used to compress the device closed around the EGC cables, creating a tight grip around the cables, preventing them slipping out of the wire supporting clamp. In some embodiments, the wire supporting clamp is made from 6000-series aluminum. According the Solar Safety Standard, UL2703, 6000-series aluminum is considered an aluminum/magnesium (Al/Mg) alloy. According to UL2703, Al/Mg can come in contact with 1000-series aluminum and it can also come in contact with copper. The wire supporting clamp shown in FIGS. 8 and 9C safely couples and bonds an aluminum EGC to a copper EGC and safely separates the EGCs, preventing galvanic corrosion.

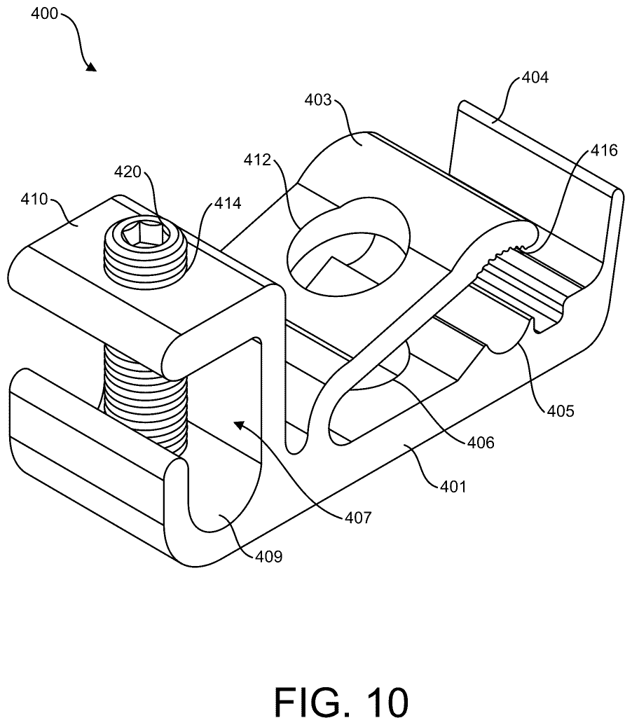

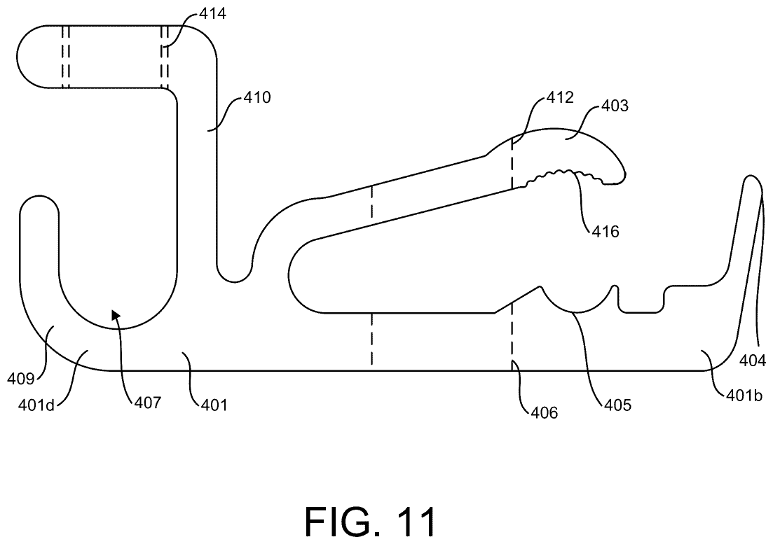

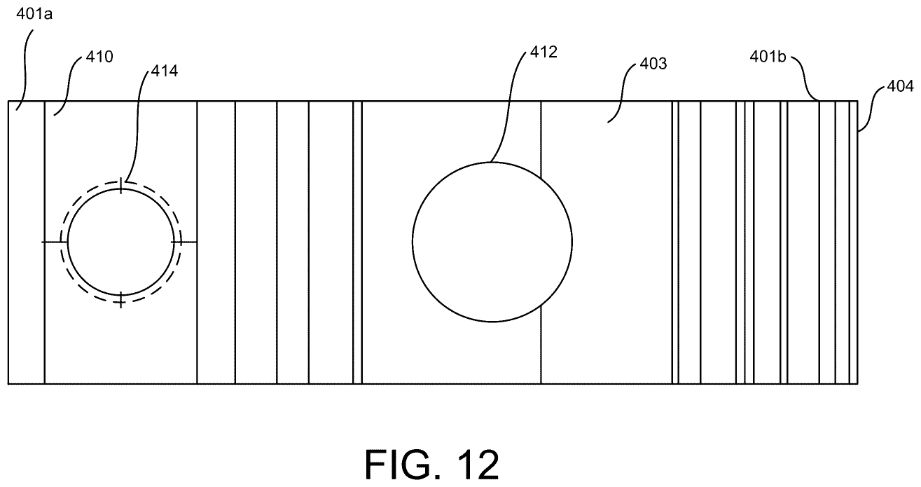

FIGS. 10-13 illustrate another embodiment of a wire supporting clamp 400. The wire supporting clamp 400 can be substantially similar to clamp 100, and therefore common features are not described in detail herein. The clamp 400 generally includes a base member 401, compression leg 403 having a curved surface 416, retention tab 404, cable saddle 405, and apertures 406, 412. A person skilled in the art would appreciate that the above description of the clamp 100 is also applicable to the additional wire supporting clamp 400. However, rather than have a flat ground clamping surface such as cable support surface 109, a cable saddle 407 is formed from a circular surface 409 and threaded fastener 420 arranged in a bracket 410, which can be used to securely couple a cable to the wire supporting clamp 400. The bracket 410 is arranged on a proximal end 401a of the base member 401, with the retention tab 404 arranged on the distal end 401b of the base member 401.

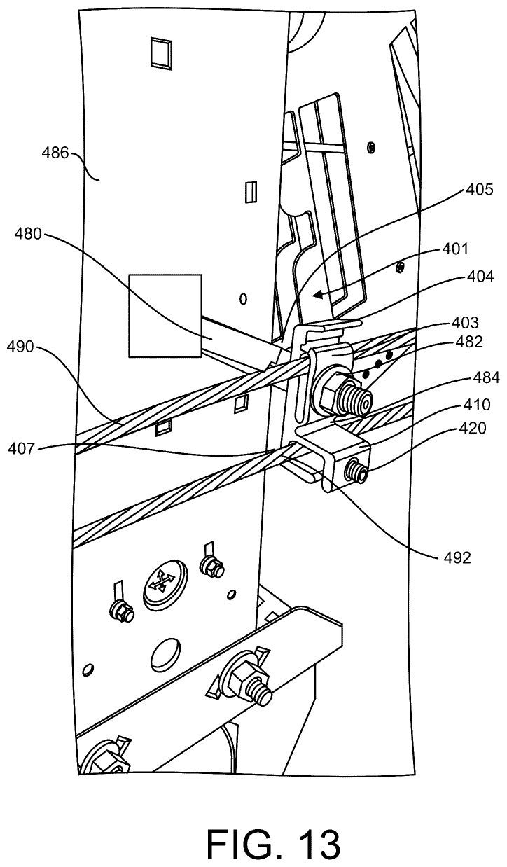

Referring now to FIG. 13, the clamp 400 can be secured to a support structure for 486 using an bolt 480. Similar to the clamp 100, bolt 480 is fed through the apertures 406, 412, where a nut 482 and a washer 484 are arranged on a threaded end of the bolt 480. The nut 482 is then tightened in order to compress the compression leg 403 on the cable 490. Additionally the cable 492 can be arranged in the cable saddle 407 and secured to the clamp by tightening the threaded fastener 420 such that it makes contact with the cable 492.

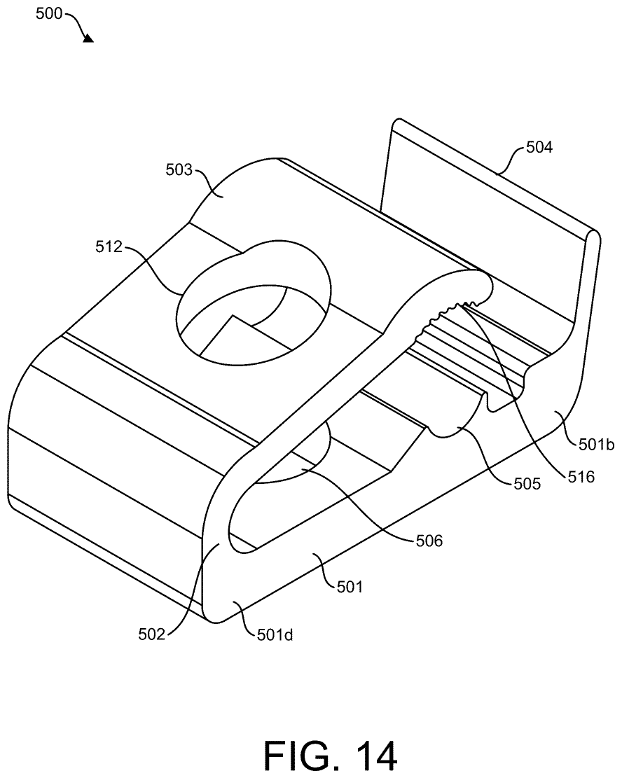

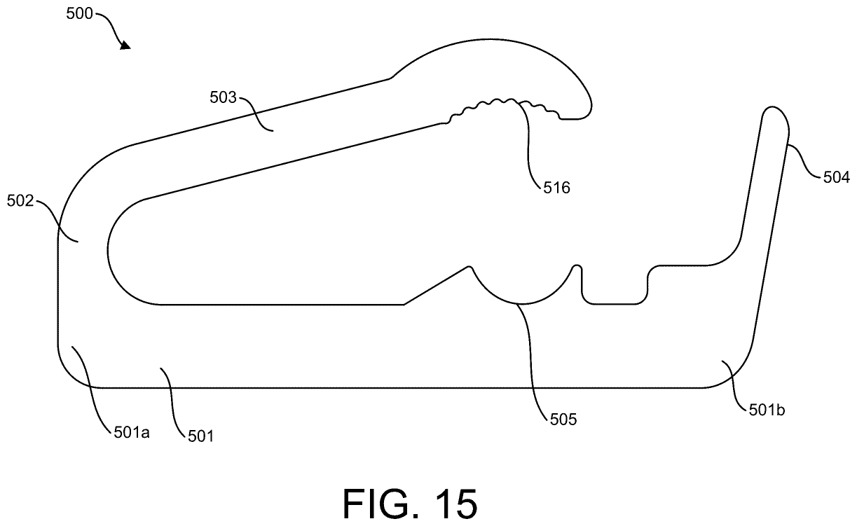

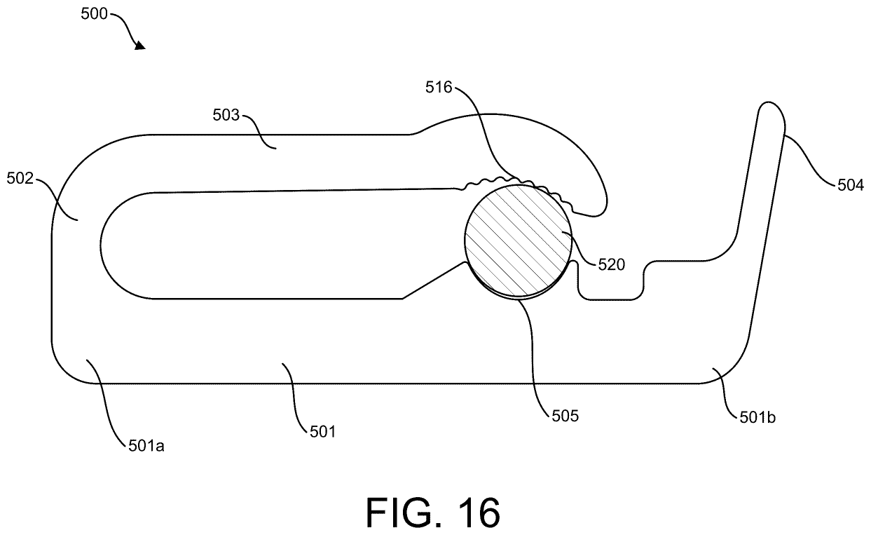

FIGS. 14-20 illustrate another embodiment of a wire supporting clamp 500. The clamp 500 is substantially similar to the clamp 100, and as such, like components will not be described in detail. The clamp 500 is generally half of the clamp 100, only including a single compression leg 503, along with the retention tab 504 and the cable saddle 505. The base 501 of the clamp 500 includes a proximal end 501a and distal end 501b. A support spine 502 extends from the proximal end 501a of the base 501, and can act as a form of the living hinge for the deformation of the compression leg 503. Aperture 506 is arranged in the base 501 and vertically aligns with aperture 512 arranged in the compression leg 503. Similar to the clamp 100, the clamp 500 is attached to a support structure using a securing means, such as a bolt, arranged within the apertures 506, 512. As shown in FIG. 16, the compression leg 503 can be to place into a compressed position in order to secure the cable 520 between the curved surface 516 and the cable saddle 505. The compression leg 503 is deformed by the tightening of a bolt (not shown) passing through the apertures 506, 512, with the bolt also securing the clamp 500 to a support structure.

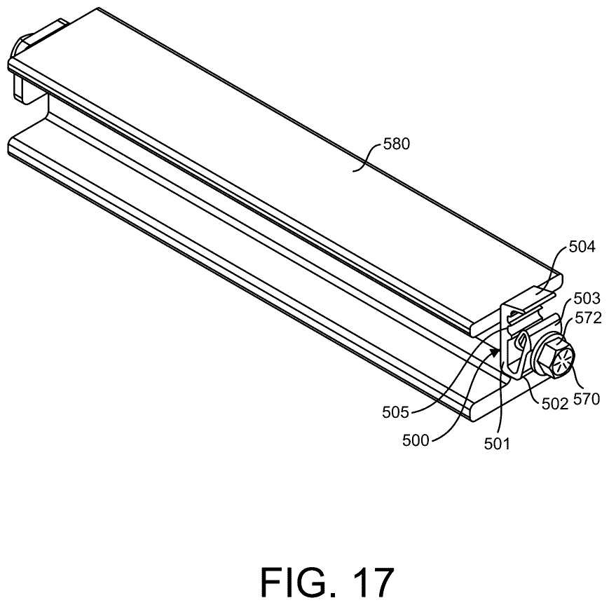

As shown in FIGS. 17-20, the wire supporting clamp 500 can be installed in various positions and orientations, providing flexibility for the installer and the surface used to couple the wire supporting clamp on. FIG. 17 illustrates a fully installed view of the non-compressed clamp 500 on a support beam 580. A bolt 570 and washer 572 are arranged on the clamp 500 such that the bolt 570 passes through a threaded aperture in the support beam 580, which connects the clamp 500 to the support beam 580, while also allowing the compression leg 503 to be placed into a compressed state by further tightening the bolt 570.

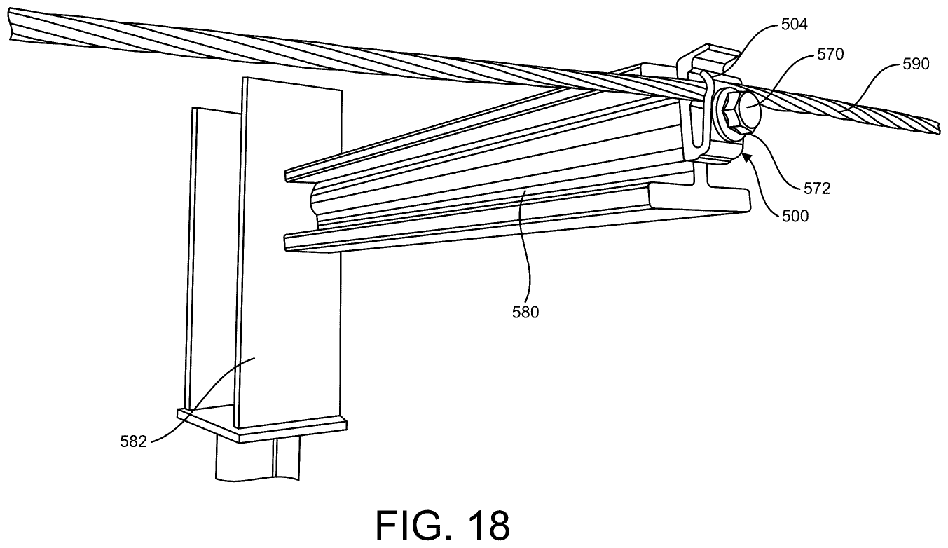

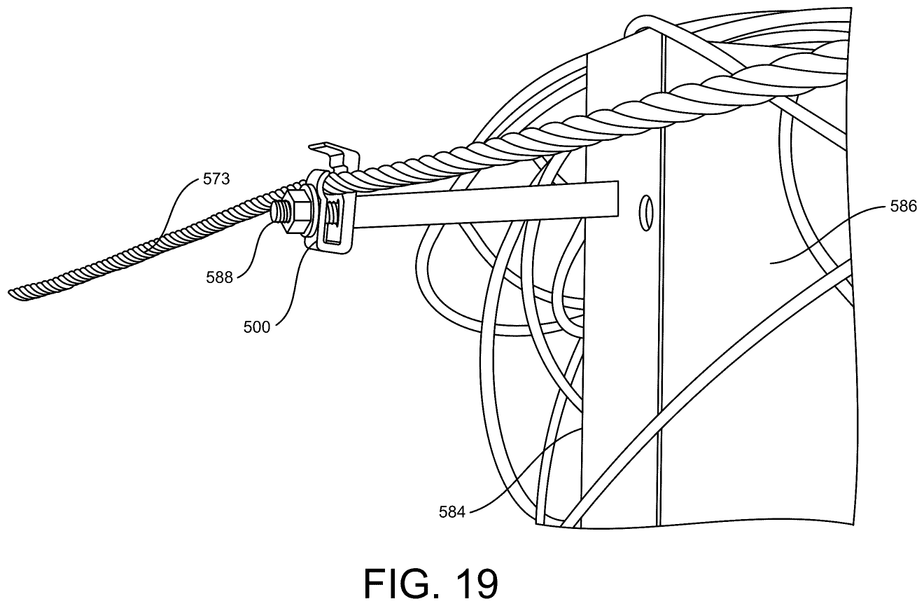

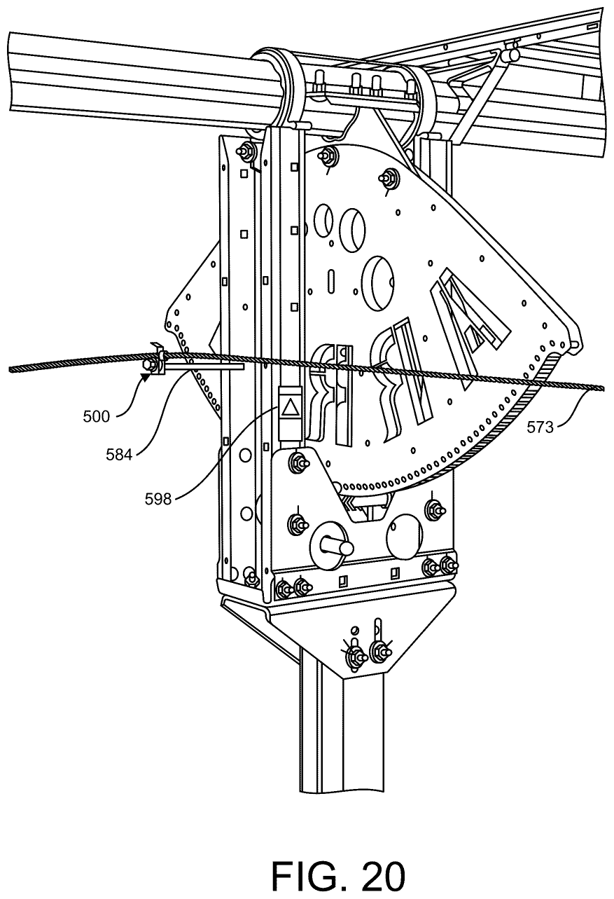

FIG. 18 illustrates the compressed clamp 500 secured to the support beam 580 using the bolt 570. The support beam 580 can be further secured to a support post 582. The cable 590 is secured to the support beam 580 using the clamp 500 with the compression leg 503 in a compressed position. FIG. 19 illustrates a fully installed compressed clamp 500 arranged on a bolt 584, with a nut 588 tightening down the compression leg 503 along the cable 573, and also securing the clamp 500 to the bolt 584. FIG. 20 illustrates a fully installed compressed clamp 500 arranged on a bolt 584, with the bolt 584 secured to a solar panel support structure 598, while also supporting cable 573.

As shown in FIGS. 17-20, the wire supporting clamp 500 described herein includes features to couple many types of cables to many types of solar panel support structures, which is advantageous to the current method of using different types of connectors to hold cables and secure cable holder to support structures.

At a utility-Scale Solar Power Plant, EGC's are routed aboveground in some areas of the plant, and buried below ground in other areas of the plant. The NEC does not allow aluminum EGC's to be buried and can only be used aboveground. Installers find it advantageous to use aluminum EGC's as it is typically more cost effective and occasionally more readily available than a copper or copper-clad steel equivalent. Since the NEC only allows copper EGC's to be buried, in some areas of the plant, the aboveground aluminum EGC has to be coupled and bonded to the copper EGC that is then buried underground. The aluminum EGC is typically made from 1000-series aluminum alloy. According to the Solar Safety Standard, UL2703, 1000-series aluminum alloy and copper should not come in contact due to galvanic corrosion concerns. Additionally, the wire supporting clamp 200 described in FIGS. 8-9C can be made from 6000-series aluminum such that it can couple, separate, and bond the copper EGC and aluminum EGC without any galvanic corrosion concerns.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A wire supporting clamp, comprising:
a base member;
a support spine extending from the base member;
a first cable saddle positioned on the base member;
a first compression leg positioned on the support spine and spaced apart from the first cable saddle;
a second cable saddle positioned on the base member; and
a second compression leg positioned on the support spine and spaced apart from the second cable saddle.

2. The wire supporting clamp of claim 1, wherein the first compression leg is deformably connected to the support spine.

3. The wire supporting clamp of claim 1, wherein the first compression leg is positioned on a first side of the support spine.

4. The wire supporting clamp of claim 3, wherein the second compression leg is positioned on a second side of the support spine, wherein the first side is opposite the second side.

5. The wire supporting clamp of claim 1, wherein the second compression leg is deformably connected to the support spine.

6. The wire supporting clamp of claim 1, wherein the first cable saddle and the second cable saddle are electrically coupled together through the wire supporting clamp to allow current to flow from the first cable saddle to the second cable saddle.

7. The wire supporting clamp of claim 1, further comprising a retention tab positioned on a distal end of the base member, distal to the first cable saddle.

8. The wire supporting clamp of claim 1, wherein the base member includes a first aperture arranged therein, and the first compression leg includes a second aperture arranged therein, wherein the first aperture and the second aperture are aligned with each other.

9. The wire supporting clamp of claim 8, wherein the first aperture and the second aperture are configured to have a securing member pass therethrough, wherein the securing member is configured to apply pressure to the first compression leg to deform the first compression leg into a compressed position.

10. The wire supporting clamp of claim 9, wherein securing member is configured to connect the wire supporting clamp to a support structure while also deforming the first compression leg.

11. The wire supporting clamp of claim 1, wherein the first cable saddle is configured to connect a first cable to the wire supporting clamp, and the second cable saddle is configured to connect a second cable to the wire supporting clamp.

12. The wire supporting clamp of claim 11, wherein the first cable and the second cable are spaced apart from each other to avoid physical contact while engaged with the first cable saddle and second cable saddle, respectively.

13. The wire supporting clamp of claim 1, wherein the wire supporting clamp is symmetrical along the support spine.

14. A wire supporting clamp, comprising:
a base member having a proximal end and a distal end;
a support spine extending from the base member;
a first compression leg positioned on the proximal end of the base member and configured to form a first cable saddle when the first compression leg is in a compressed position; and
a second compression leg positioned on the distal end of the base member and configured to form a second cable saddle when the second compression leg is in a compressed position.

15. The wire supporting clamp of claim 14, wherein the support spine at least partially forms a portion of the first cable saddle and a portion of the second cable saddle.

16. The wire supporting clamp of claim 14, wherein the first compression leg is deformably connected to the proximal end of the base member, and the second compression leg is deformably connected to the distal end of the base member.

17. The wire supporting clamp of claim 14, wherein the wire supporting clamp is symmetrical along the support spine.

18. The wire supporting clamp of claim 14, wherein the first cable saddle is configured to connect a first cable to the wire supporting clamp, and the second cable saddle is configured to connect a second cable to the wire supporting clamp.

19. The wire supporting clamp of claim 18, wherein the first cable and the second cable are spaced apart from each other to avoid physical contact while engaged with the first cable saddle and second cable saddle, respectively.

20. The wire supporting clamp of claim 14, wherein the first cable saddle and the second cable saddle are electrically coupled together through the wire supporting clamp to allow current to flow from the first cable saddle to the second cable saddle.

21. A wire supporting clamp, comprising:
a base member having a proximal end and a distal end;
a support spine arranged on the proximal end of the base member and extending from the base member;
a first cable saddle positioned on the base member; and
a first compression leg deformably connected to the support spine and spaced apart from the first cable saddle.

22. The wire supporting clamp of claim 21, further comprising a retention tab positioned on the distal end of the base member, distal to the first cable saddle.

23. The wire supporting clamp of claim 21, wherein the base member includes a first aperture arranged therein, and the first compression leg includes a second aperture arranged therein, wherein the first aperture and the second aperture are aligned with each other.

24. The wire supporting clamp of claim 23, wherein the first aperture and the second aperture are configured to have a securing member pass therethrough, wherein the securing member is configured to apply pressure to the first compression leg to deform the first compression leg into a compressed position.

25. The wire supporting clamp of claim 24, wherein securing member is configured to connect the wire supporting clamp to a support structure while also deforming the first compression leg.

26. The wire supporting clamp of claim 22, wherein the first compression leg includes a curved surface corresponding to and aligned with the first cable saddle.

27. The wire supporting clamp of claim 26, wherein the curved surface and the first cable saddle secure the wire supporting clamp to a wire arranged between the curved surface and the first cable saddle when the first compression leg is in a compressed position.
